(19) United States
(12) Patent Application Publication
(10) Pub. No.: US 2005/0285839 A1
(43) Pub. Date: Dec. 29, 2005

(54) Driving circuit of liquid crystal display device and method for driving the same

(76) Inventor: In Hwan Kim, Seoul (KR)

Correspondence Address: MCKENNA LONG & ALDRIDGE LLP, 1900 K STREET, NW, WASHINGTON, DC, 20006, US

(21) Appl. No.: 11/156,588

(22) Filed: Jun. 21, 2005

(30) Foreign Application Priority Data
Jun. 28, 2004 (KR) 2004-49020

(51) Int. Cl. G09G 3/36

(52) U.S. Cl. 345/100

(57) ABSTRACT

A driving circuit for an LCD device, and a method for driving the same, that minimizes RC delay is provided. The driving circuit includes a clock signal generating unit for outputting a clock signal at a predetermined period; a plurality of latches connected in series for sampling inputted digital data, and shifting and storing the sampled digital data to the next latch in the series; a holding latch unit for simultaneously reading and outputting the sampled digital data stored in the plurality of latches; and a digital-to-analog converter unit for converting the sampled digital data outputted from the holding latch unit to analog data, and applying the analog data to data lines of an LCD panel.

This application claims the benefit of the Korean Application No. P2004-49020 filed on Jun. 28, 2004, which is hereby incorporated by reference for all purposes as if fully set forth herein.

### BACKGROUND OF THE INVENTION

1. Field of the Invention

The present invention relates to a liquid crystal display (LCD) device, and more particularly, to a driving circuit for an LCD device and a method for driving the same, that minimizes RC delay.

2. Discussion of the Related Art

In general, an LCD device displays picture images by controlling the transmittance of liquid crystals with an electric field. The LCD device includes an LCD panel that includes liquid crystal cells arranged in a matrix and a driving circuit that drives the LCD panel. In addition, the LCD device includes integrated circuits (ICs) for driving data and gate lines, referred to as data drive ICs and gate drive ICs respectively. The data drive ICs contact the LCD panel through a tape carrier package (TCP), and the gate drive ICs also contact the LCD panel through a gate TCP.

The LCD panel includes a plurality of gate lines, a plurality of data lines, a plurality of thin film transistors, and liquid crystal cells, wherein a thin film transistor is formed at each crossing point of the gate and data lines, and a liquid crystal cell is in contact with each thin film transistor. Each thin film transistor has a gate electrode and a source electrode, wherein the gate electrode of the thin film transistor is in contact with any one of the gate lines by a horizontal line group, and the source electrode of the thin film transistor is in contact with any one of the data lines by a vertical line group. The thin film transistor responds to a gate driving pulse from the gate line, whereby digital data of the data line is provided to the liquid crystal cell.

The liquid crystal cell is comprised of a pixel electrode and a common electrode, wherein the pixel electrode is in contact with a drain electrode of the thin film transistor, and the common electrode is positioned opposite the pixel electrode and liquid crystals are interposed therebetween. The liquid crystal cell responds to the digital data provided to the pixel electrode, thereby controlling transmittance by driving the liquid crystal cell.

The gate drive ICs are mounted on the gate TCP, and are electrically connected with gate pads of the LCD panel through the gate TCP. The gate drive ICs drive the gate lines of the LCD panel in sequence by one horizontal period (1H). Likewise, the data drive ICs are mounted on the data TCP, and are electrically connected with data pads of the LCD panel through the data TCP. The data drive ICs convert digital data to analog data, and provide the analog data to the data lines of the LCD panel by one horizontal period (1 H).

Hereinafter, a data drive IC of an LCD device according to the related art will be described with reference to the accompanying drawings.

FIG. 1 is a block diagram of data drive IC according to the related art. As illustrated in FIG. 1, the related art data drive IC includes: a shift register unit 10; a data register unit 90; a sampling latch unit 40; a holding latch unit 50; a digital-analog converter DAC 60; and a buffer unit 70. The shift register unit 10 provides sampling signals in sequence, and the data register unit 90 relays digital data outputted from a timing controller. Also, the sampling latch unit 40 responds to the sampling signal of the shift register 10, and samples and latches the digital data supplied on a data transmission line 25. Then, the holding latch unit 50 reads the sampled digital data outputted from the sampling latch unit 40, and simultaneously outputs the read digital data. The DAC 60 converts the sampled digital data outputted from the holding latch unit 50 to analog data using a gamma voltage from a gamma voltage unit 80. The buffer unit 70 buffers and outputs the analog data of the DAC 60. The sampling latch unit 40 is provided with a plurality of latches 30 for sampling and latching the digital data in response to the sampling signal of the shift register unit 10.

An operation of the data drive IC according to the related art will be described as follows.

First, the data register unit 90 relays the digital data outputted from the timing controller (not shown), and applies the digital data to the data transmission line 25 of the sampling latch unit 40. Then, the latches 30 of the sampling latch unit 40 respond to the sampling signals of the shift register 10 in sequence, thereby sampling and storing the digital data in a predetermined unit.

Subsequently, the holding latch unit 50 simultaneously reads and outputs the sampled digital data inputted from the sampling latch unit 40 in response to a source enable signal inputted from the timing controller (not shown). After that, the DAC 60 converts the sampled digital data inputted from the holding latch unit 50 to analog data using the gamma voltage GH and GL from the gamma voltage unit 80, and outputs the analog data. Next, the analog data outputted from the DAC 60 is outputted to the data line of the LCD panel through the buffer unit 70.

As the size of the LCD panel increases, the length of the data transmission line 25 increases, increasing resistance and capacitance factors. Accordingly, the digital data transmitted through the data transmission line 25 subjected to RC delay due to resistance and capacitance factors of the transmission line.

The RC delay the digital data is subjected to increases as the data is transmitted from one end of the data transmission line 25 to the other. As a result, the latch 30 positioned at the end of the data transmission line 25 furthered from the data register unit 90 has the greatest RC delay. That is, as the length of the data transmission line 25 increases, the RC delay of the digital data increases, so that it is impossible to perform the correct sampling function in the sampling latch unit 40.

In addition, methods for providing a minimum number of data drive ICs has been actively researched and studied in order to decrease the manufacturing cost. However, minimizing the number of data drive ICs makes it is necessary to increase the number of output lines provided in one data drive IC. As the number of output lines increases, the number of latches 30 also increases. As a result, the resistance and capacitance in the data transmission line 25 increases. Accordingly, in case of the related art data drive IC, it is difficult to increase the number of output lines of the data drive IC.

### SUMMARY OF THE INVENTION

Accordingly, the present invention is directed to a driving circuit for an LCD device and a method for driving the same that substantially obviates one or more problems due to limitations and disadvantages of the related art.

An advantage of the present invention is to provide a driving circuit of an LCD device, and a method for driving the same, in which a sampling latch unit is provided that minimizes RC delay of the digital data.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these objects and other advantages and in accordance with the purpose of the invention, as embodied and broadly described, a driving circuit of an LCD device is provided comprising a clock signal generating unit for outputting a clock signal at a predetermined period; a plurality of latches connected in series, at least one of the plurality of latches sampling inputted digital data, and each latch shifting and storing the sampled digital data to the next latch in the series; a holding latch unit for simultaneously reading and outputting the sampled digital data stored in said plurality of latches; and a digital-to-analog converter (DAC) unit for converting the sampled digital data outputted from the holding latch unit to analog data, and applying the analog data to a plurality of data lines of an LCD panel.

In another aspect, a driving circuit for an LCD device includes a clock signal generating unit for outputting a clock signal at a predetermined period; a sampling latch unit for sampling inputted digital data and outputting sampled digital data; a plurality of latches connected in series, each latch shifting and storing the sampled digital data outputted from the sampling latch unit to the next latch in the series; a holding latch unit for simultaneously reading and outputting the sampled digital data stored in the plurality of latches; and a digital-to-analog converter (DAC) unit for converting the sampled digital data outputted from the holding latch unit to analog data, and providing the analog data to data lines of an LCD panel.

In another aspect, a method for driving a driving circuit of an LCD device includes generating a clock signal; in response to the clock signal, sampling inputted digital data, and shifting and storing the sampled digital data in a sequence of latches; when each latch the sequence of latches contains sampled digital data, simultaneously reading and outputting the sampled digital data stored in the sequence of latches; and converting the outputted sampled digital data to analog data.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

In the drawings:

FIG. 1 is a block diagram of a related art data drive IC;

FIG. 2 is a block diagram of a driving unit in an LCD device according to a first embodiment of the present invention;

FIG. 3A to FIG. 3D are schematic views illustrating a sampling process using a sampling latch unit as illustrated in FIG. 2;

FIG. 4 is a block diagram of a driving unit in an LCD device according a second embodiment of the present invention; and

FIG. 5A to FIG. 5D are schematic views illustrating a sampling process using a sampling latch unit as illustrated in FIG. 4.

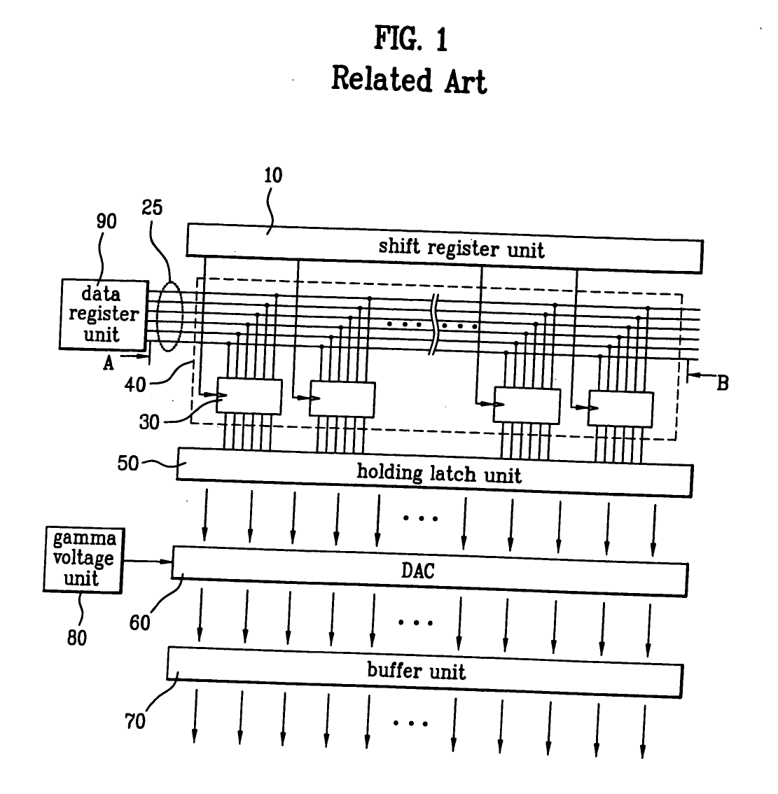

### DETAILED DESCRIPTION OF THE INVENTION

Reference will now be made in detail to embodiments of the present invention, examples of which are illustrated in the accompanying drawings.

Hereinafter, a driving circuit of an LCD device according to the present invention will be described as follows.

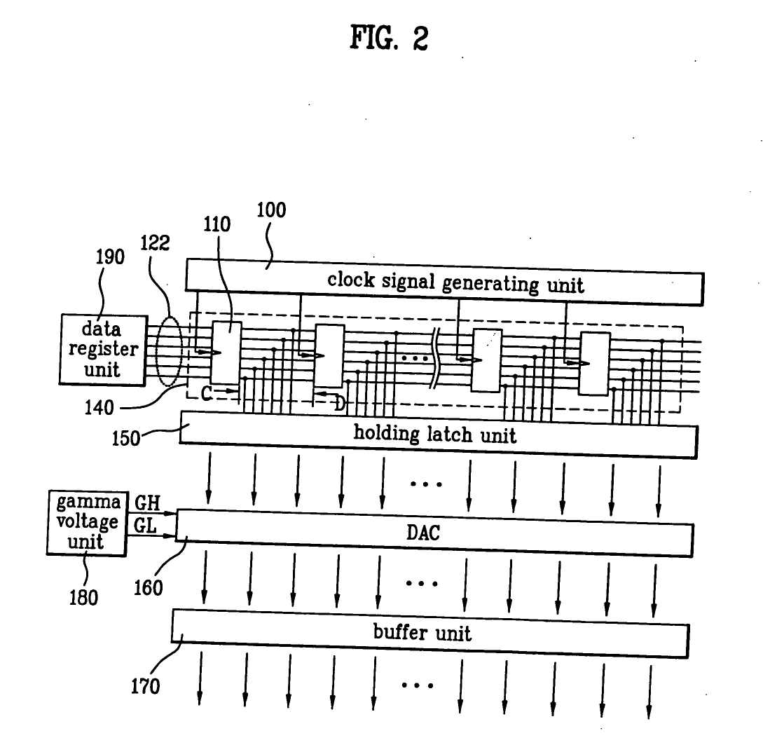

FIG. 2 is a block diagram illustrating a driving circuit for an LCD device according to a first embodiment of the present invention. As illustrated in FIG. 2, the driving circuit of the LCD device includes: a clock signal-generating unit 100; a sampling latch unit 140 provided with a plurality of latches connected in series; a holding latch unit 150, a digital-to-analog converter (DAC) unit 160; and a buffer unit 170. The clock signal-generating unit 100 outputs a clock signal at a predetermined period. The latch 110 closest to the data register unit samples the inputted digital data, and each of the latches shifts and stores the sampled digital data to the next latch in the series. Also, the holding latch unit 150 simultaneously reads the sampled digital data stored in the latches 110 of the sampling latch unit 140, and outputs the digital data. The DAC unit 160 converts the sampled digital data inputted from the holding latch unit 150 to analog data by using gamma voltages GH and GL from a gamma voltage unit 140. The buffer unit 170 buffers and outputs the analog data inputted from the DAC unit 160.

Specifically, the latches 110 are connected in series by data transmission lines 122 for transmitting the digital data. Also, one end of each of the data transmission lines 122 is connected with a data register unit 190. The data register unit 190 relays the digital data outputted from a timing controller (not shown), and provides the digital data to the data transmission lines 122. The latch 110 positioned nearest to the data register unit 190 initially receives the digital data from the data register unit 190, and samples the digital data.

Although not shown, the holding latch unit 150 is provided with a plurality of holding latches. The plurality of holding latches are respectively provided in correspondence to the plurality of latches 110 of the sampling latch unit 140, wherein the plurality of holding latches read the sampled digital data, and simultaneously output the digital data. Also, the DAC unit 160 includes a plurality of DACs, wherein the plurality of DACs correspond to the holding latches of the holding latch unit 150, to convert the sampled digital data to the analog data. More specifically, the DACs are formed of positive polarity DACs and negative polarity DACs, wherein the positive polarity DACs convert the sampled digital data to the positive polarity analog data (GH), and the negative polarity DACs convert the sampled digital data to the negative polarity analog data (GL). At this time, the positive polarity DACs and the negative polarity DACs are positioned such that each positive polarity DAC alternates with each negative polarity DAC. Also, the buffer unit 170 is provided with a plurality of buffers, wherein the plurality of buffers respectively correspond to the positive and negative polarity DACs, to buffer and output the analog data.

The sampled digital data sequentially shifted and latched by the latches 110 has less RC delay, as compared with the related art. Because the sampled digital data is buffered through the latches 110, the only resistance and capacitance factor that affects the data is the portion (for example, between C block and D block) formed between the latches 110. In contrast, in the related art the entire data transmission line 122 effects the RC delay of the sampled digital data. Thus, the RC delay of the sampled digital data stored in the last latch 110 is decreased, as compared with the related art.

The sampled digital data shifted and inputted into each latch 110 has the same RC delay. That is, the sampled digital data inputted to the first latch, positioned nearest to the data register unit 190, has the same RC delay as the sampled digital data inputted to the last latch, positioned farthest from the data register unit 190. Also, the sampled digital data inputted into the latches 110 positioned between the first latch and the last latch has the same RC delay.

Accordingly, when designing the data drive IC with a sampling latch unit 140 according to the present invention, it is possible to correctly sample the digital data at high frequencies, for example, above about 500 Mhz. In addition, it is possible to obtain the data drive IC having the plurality of output lines and realizing the correct sampling function.

An operation of the LCD device according to the first embodiment of the present invention will be described as follows.

The timing controller (not shown) classifies the digital data into odd numbered digital data and even numbered digital data, to decrease transmittance frequency, and then separately provides the odd numbered digital data and the even numbered digital data to the data register unit 190 through respective transmission lines. Then, the data register unit 190 outputs the odd numbered digital data and the even numbered digital data to the first latch 110 via data transmission line 122.

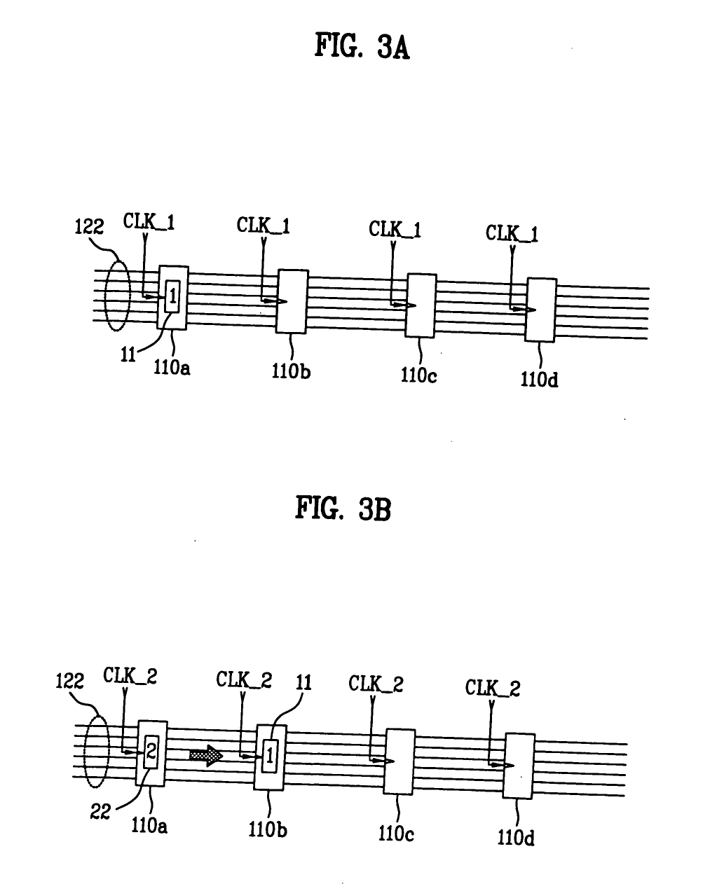

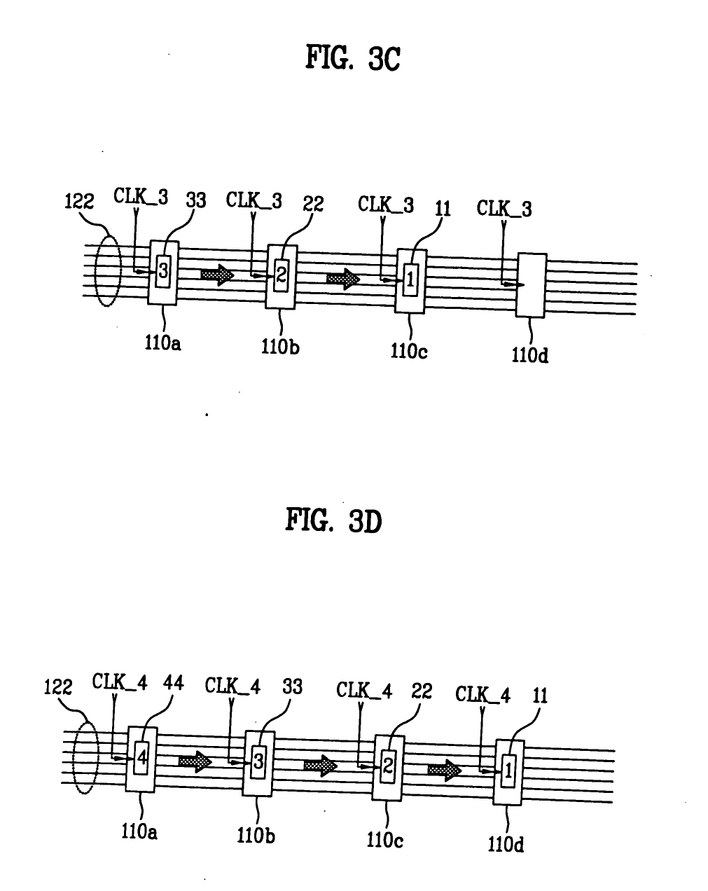

The first latch 110 samples the digital data in response to the clock signal of the clock signal-generating unit 110, and then shifts the sampled digital data to the next latch. Then, the second latch 110 shifts the sampled digital data shifted from the first latch 110 to the third latch 110 in response to the clock signal. In this method, the sampled digital data is shifted to the last latch 110, and the last latch 110 stores the sampled digital data, as illustrated in FIG. 3A to 3D, supposing that the four latches 110a, 110b, 110c and 110d are provided.

First, as illustrated in FIG. 3A, if the first clock signal (CLK_1) outputted from the clock signal-generating unit 100 is inputted to the first to fourth latches 110a, 110b, 110c and 110d, the first latch 1110a samples and stores the digital data inputted from the data register unit 190 in response to the first clock signal (CLK_1). That is, the first sampled digital data 11 is stored to the first latch 110a at the point of outputting the first clock signal (CLK_1).

Subsequently, as illustrated in FIG. 3B, when the second clock signal (CLK_2) is supplied from the clock signal-generating unit 100 to the first to fourth latches 110a, 110b, 110c and 110d, the first latch 110a shifts and inputs the first sampled digital data 11 to the second latch 110b in response to the second clock signal (CLK_2), and simultaneously, the first latch 110a samples and stores the digital data inputted from the data register unit 190. Accordingly, after the second clock signal (CLK_2), the second sampled digital data 22 is stored in the first latch 110a, and the first sampled digital data 11 is stored in the second latch 110b.

Next, as illustrated in FIG. 3C, when the third clock signal (CLK_3) is supplied from the clock signal-generating unit 100 to the first to fourth latches 110a, 110b, 110c and 110d, the second latch 110b shifts and inputs the first sampled digital data 11 to the third latch 110c in response to the third clock signal (CLK_3). Simultaneously, the first latch 110a shifts and inputs the second sampled digital data 22 to the second latch 110b, and samples and stores the digital data inputted from the data register unit 190. Accordingly, after, the third clock signal (CLK_3), the third sampled digital data 33 is stored in the first latch 110a, the second sampled digital data 22 is stored in the second latch, and the first sampled digital data 11 is stored in the third latch 110c.

Subsequently, as illustrated in FIG. 3D, when the fourth clock signal (CLK_4) is supplied from the clock signal-generating unit 100 to the first to fourth latches 110a, 110b, 110c and 110d, the first latch 110a shifts and inputs the third sampled digital data 33 to the second latch 110b in response to the fourth clock signal (CLK_4), and simultaneously, samples and stores the digital data inputted from the data register unit 190. Also, the second latch 110b shifts and inputs the second sampled digital data 22 to the third latch 110c in response to the fourth clock signal (CLK_4). The third latch 110c shifts and inputs the first sampled digital data 11 to the fourth latch 110d in response to the fourth clock signal (CLK_4). Accordingly, after the fourth clock signal (CLK_4), the fourth sampled digital data 44 is stored in the first latch 110a, the third sampled digital data 33 is stored in the second latch 110b, the second sampled digital data 22 is stored in the third latch 110c, and the first sampled digital data 11 is stored in the fourth latch 110d.

As shown in FIGS. 3A-3D, the sampled data is reversed from that of the related art driving method. In other words, the first sampled data is stored in the last latch as opposed to the first latch. To prevent this from occurring, a bidirectional data register may be used such that the digital data is applied to the last latch (latch 110d in FIGS. 3A-3D) first. As a result, the first sampled data is stored in the first latch. Alternatively, the digital data may be supplied to the data register unit in a reversed form. For example, the timing controller may reverse the digital data prior to supplying it to the data register unit.

Accordingly, the latches 110a, 110b, 110c and 110d sequentially shift and store the four sampled digital data 11, 22, 33 and 44 in response to the four clock signals (CLK_1, CLK_2, CLK_3 and CLK_4). The sampling and latching operation of the sampling latch unit 140 is substantially completed when the first sampled digital data 11 is stored in the fourth latch 110d. Because, the first sampled digital data 11 is buffered through the second and third latches 110b and 110c before it is stored in the fourth latch 110d, the sampled digital data 11 stored in the fouth latch 110d and the sampled digital data 44 stored in the first latch 10a have the same RC delay. Also, the third and second sampled digital data 33 and 22 stored in the second and third latches 110b and 110c have the same RC delay. In addition, the RC delay corresponds to the length of the portion (for example, between C block and D block) of the data transmission line 122 formed between the latches 110a, 110b, 110c and 110d. Therefore, the RC delay is smaller than the RC delay in the related art.

The holding latch unit 150 then reads the sampled digital data 11, 22, 33 and 44 stored in the latches 110a, 110b, 110c and 110d in response to a source enable signal inputted from the timing controller (not shown), and simultaneously outputs the sampled digital data. For example, the holding latch unit 150 may simultaneously read the sampled digital data 11, 22, 33 and 44 at the rising edge of the source enable signal, and simultaneously output the sampled digital data at the falling edge of the source enable signal.

The DAC unit 160 converts the sampled digital data 11, 22, 33 and 44 outputted from the holding latch unit 150 to analog data using the positive and negative polarity gamma voltages GH and GL outputted from the gamma voltage unit 180. The analog data is then provided to the data line of the LCD panel via the buffer unit 170.

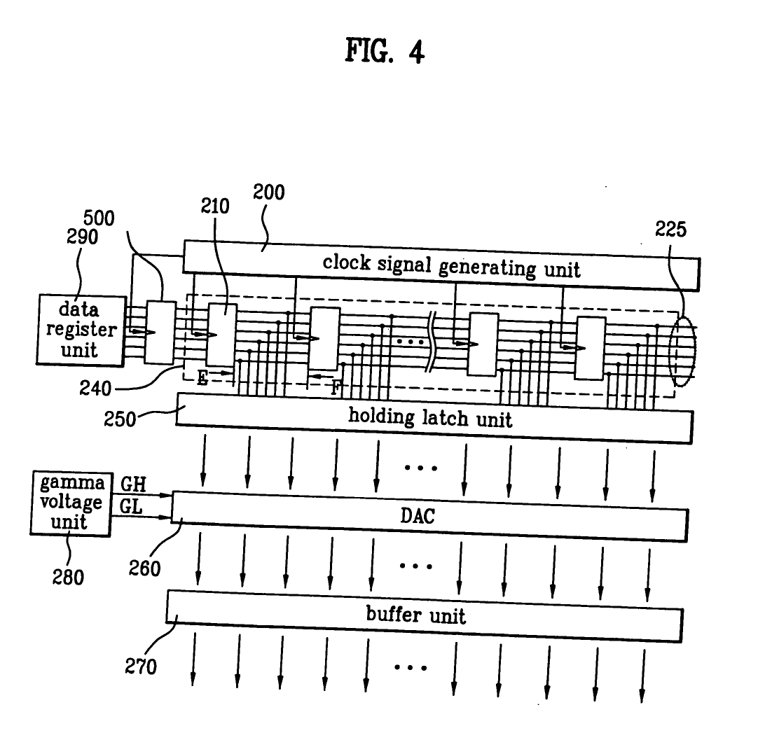

A driving circuit for an LCD device according to a second embodiment of the present invention is illustrated in FIG. 4. As illustrated in FIG. 4, the driving circuit of the LCD device according to the second embodiment of the present invention includes: a clock signal-generating unit 200; a sampling unit 500; a sampling latch unit 240 that includes a plurality of latches connected in series; a holding latch unit 250; a digital-to-analog converter (DAC) unit 260; and a buffer unit 270. The clock signal-generating unit 200 outputs clock signals at a predetermined period, and the sampling unit 500 samples inputted digital data in response to the clock signal. Also, the sampling latch unit 240 shifts and stores the sampled digital data outputted from the sampling unit 500 in response to the clock signal. Then, the holding latch unit 250 simultaneously reads and outputs the sampled digital data stored in latches 210 and provides the sampled digital data to the DAC unit 260 where it is converted to analog data using gamma voltages GH and GL outputted from a gamma voltage unit 240. Buffer unit 270 buffers and outputs the analog data outputted from the DAC unit 260.

The sampling unit 500 and the latches 210 are connected in series by data transmission lines 225 for transmitting the digital data. Also, one end of each of the data transmission lines 225 is connected to a data register unit 290. The data register unit 290 relays digital data outputted from a timing controller (not shown), and provides the digital data to the data transmission lines 225. The sampling unit 500 positioned nearest to the data register unit 290 initially receives the digital data outputted from the data register unit 290, and then samples the digital data in response to the clock signal.

Although not shown, the holding latch unit 250 is provided with a plurality of holding latches. The plurality of holding latches are respectively provided in correspondence to the plurality of latches 210 of the sampling latch unit 240, wherein the plurality of holding latches simultaneously latch and output the sampled digital data. In addition, the DAC unit 260 includes a plurality of DACs, wherein the plurality of DACs correspond to the holding latches of the holding latch unit 250, that convert the sampled digital data to analog data. For example, the DACs may be formed of positive polarity DACs and negative polarity DACs, wherein the positive polarity DACs convert the sampled digital data to the positive polarity analog data (GH), and the negative polarity DACs convert the sampled digital data to the negative polarity analog data (GL). The positive polarity DACs and the negative polarity DACs are positioned such that each positive polarity DAC alternates with each negative polarity DAC. In addition, the buffer unit 270 is provided with a plurality of buffers, wherein the plurality of buffers respectively correspond to the positive and negative polarity DACs, to buffer and output the analog data.

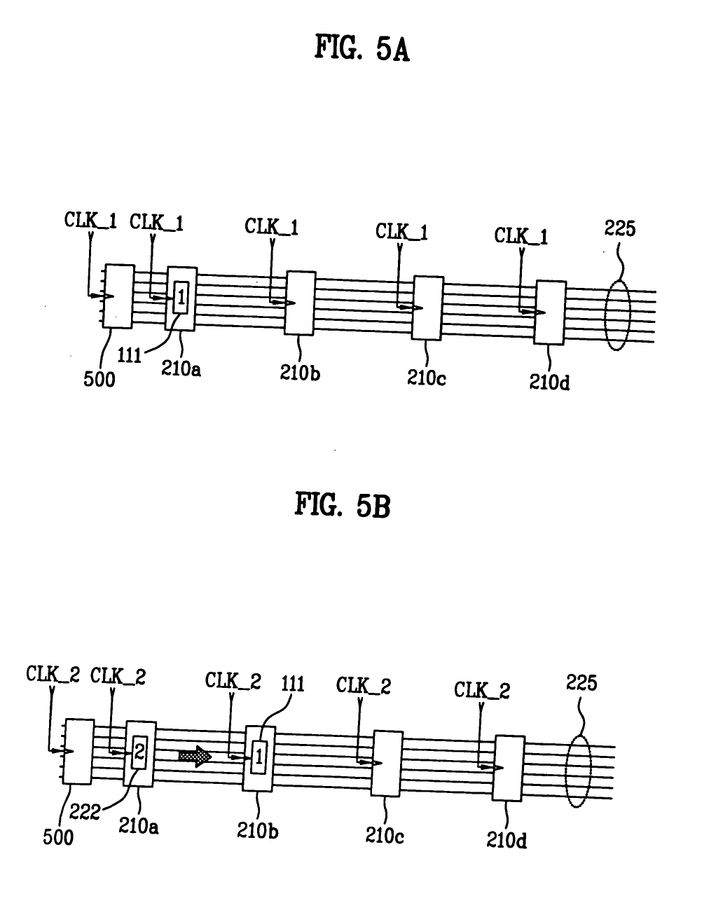

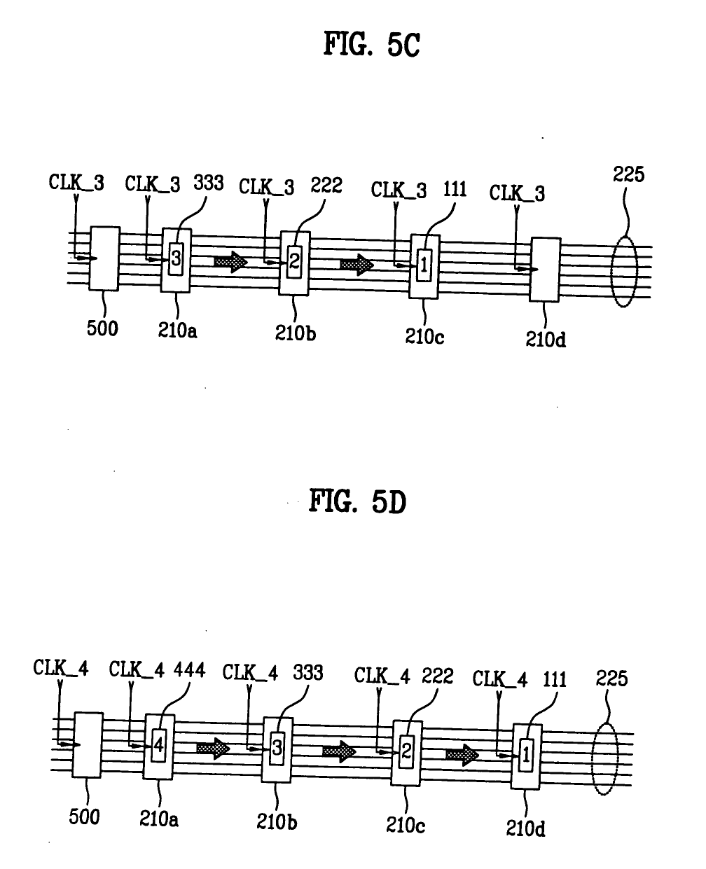

FIG. 5A to FIG. 5D illustrate the sampling process using a sampling latch unit as illustrated in FIG. 4, assuming four latches 210a, 210b, 210c and 210d are provided. As illustrated in FIG. 5A, when the first clock signal (CLK_1) is supplied from the clock signal-generating unit 200 to the first to fourth latches 210a, 210b, 210c and 210d, the sampling unit 500 samples and shifts the digital data inputted from the data register unit 290, and then supplies the sampled digital data to the first latch 210a. Accordingly, after the first clock signal (CLK_1), the first sampled digital data 111 is stored in the first latch 210a.

As illustrated in FIG. 5B, when the second clock signal (CLK_2) is supplied from the clock signal-generating unit 200 to the first to fourth latches 210a, 210b, 210c and 210d, and the sampling unit 500, the sampling unit 500 samples and shifts the digital data inputted from the data register unit 290, and then supplies the sampled digital data to the first latch 210a. Simultaneously, the first latch 210a shifts the first sampled digital data 111 to the second latch 110b. Accordingly, after the second clock signal (CLK_2), the second sampled digital data 222 is stored in the first latch 110a, and the first sampled digital data 111 is stored in the second latch 210b.

As illustrated in FIG. 5C, when the third clock signal (CLK_3) is supplied from the clock signal-generating unit 200 to the first to fourth latches 210a, 210b, 210c and 210d, and the sampling unit 500, the sampling unit 500 samples the digital data outputted from the data register unit 290 and supplies the sampled digital data to the first latch 210a. Simultaneously, the first latch 210a shifts and inputs the second sampled digital data 222 to the second latch 210b, and the second latch 210b shifts and inputs the first sampled digital data 111 to the third latch 210c. Accordingly, after the third clock signal (CLK_3), the third sampled digital data 333 is stored in the first latch 110a, the second sampled digital data 222 is stored in the second latch 110b, and the first sampled digital data 111 is stored in the third latch 110c.

Subsequently, as illustrated in FIG. 5D, when the fourth clock signal (CLK_4) is supplied from the clock signal-generating unit 200 to the first to fourth latches 210a, 210b, 210c and 210d, and the sampling unit 500, the sampling unit 500 samples and shifts the digital data inputted from the data register unit 290, and supplies the sampled digital data to the first latch 210a. Simultaneously, the first latch 210a shifts and inputs the third sampled digital data 333 to the second latch 210b, and the second latch 210b shifts and inputs the second sampled digital data 222 to the third latch 210c. The third latch 210c inputs the first sampled digital data 111 to the fourth latch 210d. Accordingly, after the fourth clock signal (CLK_4), the fourth sampled digital data 444 is stored in the first latch 210a, the third sampled digital data 333 is stored in the second latch 210b, the second sampled digital data 222 is stored in the third latch 210c, and the first sampled digital data 111 is stored in the fourth latch 210d.

In response to the four clock signals (CLK_1, CLK_2, CLK_3 and CLK_4), the latches 210a, 210b, 210c and 210d shift and store the four sampled digital data 111, 222, 333 and 444 in sequence. The sampling and latching operation of the sampling latch unit 240 is substantially completed when the first sampled digital data 111 is stored in the fourth latch 210d. Because the first sampled digital data 111 is buffered through the second latch 210b and the third latch 210c, it has the same RC delay as the fourth sampled digital data 444 stored in the first latch 210a, and the third and second sampled digital data 333 and 222 stored in the second and third latches 210b and 210c. Furthermore, the RC delay corresponds to the length of the portion (for example, between block E and block F) of the data transmission line 225 formed between the latches 210a, 210b, 210c and 210d. Therefore, the RC delay is smaller than that of the related art.

After the sample data is stored in each of the latches 210a, 210b, 210c, and 210d, the holding latch unit 250 simultaneously reads the sampled digital data 111, 222, 333 and 444 stored in the latches 210a, 210b, 210c and 210d of the sampling latch unit 240 in response to a source enable signal inputted from the timing controller (not shown). For example, the holding latch unit 250 may simultaneously read the sampled digital data 111, 222, 333 and 444 at the rising edge of the source enable signal, and simultaneously output the sampled digital data at the falling edge of the source enable signal.

The DAC unit 160 then converts the sampled digital data 111, 222, 333 and 444 to analog data using the positive and negative polarity gamma voltages GH and GL outputted from the gamma voltage unit 280, and outputs the analog data. Next, the buffer unit 270 buffers and provides the analog data outputted from the DAC unit 260 to the data line of the LCD panel.

As described above, the data driving circuit and the method of driving the same according to a second embodiment f the invention minimizes the RC delay of the sampled digital data, and prevents increases in the RC delay. Accordingly, even though the length of the data transmission line may increase, it is possible to correctly sample the digital data. Also, it is possible to increase the number of output lines provided to one data drive IC, thereby decreasing the number of data drive ICs for the LCD panel.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

1. A driving circuit for an LCD device comprising:
a clock signal generating unit for outputting a clock signal at a predetermined period;
a plurality of latches connected in series, at least one of the plurality of latches samples inputted digital data, and each latch shifts and stores the sampled digital data to the next latch in the series;
a holding latch unit for simultaneously reading the data stored in said plurality of latches and outputting the read data; and
a digital-to-analog converter (DAC) unit for converting the sampled digital data outputted from the holding latch unit to analog data, and outputting the analog data to a plurality of data lines of an LCD panel.

2. The driving circuit of claim 1, wherein the plurality of latches are connected in series by a data transmission line that transmits the digital data.

3. The driving circuit of claim 2, further comprising:
a data register unit connected to one end of the data transmission line, said data register unit providing the digital data to the data transmission line.

4. The driving circuit of claim 3, wherein the latch closest to the data register unit samples the digital data.

5. The driving circuit of claim 1, further comprising:
a buffer unit for buffering the analog data outputted from the DAC unit, and providing the buffered analog data to the plurality of data lines.

6. A driving circuit for an LCD device comprising:
a clock signal generating unit for outputting a clock signal at a predetermined period;
a sampling latch unit for sampling inputted digital data and outputting sampled digital data;
a plurality of latches connected in series, each latch in the series of latches shifting and storing the sampled digital data inputted from the sampling latch unit to the next latch in the series;
a holding latch unit for simultaneously reading the data stored in said plurality of latches and outputting the read data; and
a digital-to-analog converter (DAC) unit for converting the sampled digital data outputted from the holding latch unit to analog data, and providing the analog data to data lines of an LCD panel.

7. The driving circuit of claim 6, wherein the plurality of latches are connected in series by a data transmission line that transmits the digital data.

8. The driving circuit of claim 7, further comprising:
a data register unit connected to one end of the data transmission line, said data register unit providing the digital data to the data transmission line.

9. The driving circuit of claim 8, wherein the sampling latch unit is positioned between the data register unit and the plurality of latches.

10. The driving circuit of claim 6, further comprising:
a buffer unit for buffering the analog data outputted from the DAC unit, and providing the buffered analog data to the plurality of data lines.

11. The driving circuit of claim 1, further comprising:
a gamma voltage unit connected to the digital-to-analog converter unit.

12. The driving circuit of claim 6, further comprising:
a gamma voltage unit connected to the digital-to-analog converter unit.

13. A method for driving a driving circuit of an LCD device comprising:
generating a clock signal;
in response to the clock signal, sampling inputted digital data, then shifting and storing the sampled data in a sequence of latches;
when each latch in the sequence of latches contains sampled digital data, simultaneously reading the sampled, then storing the digital data and outputting the stored digital data; and
converting the outputted digital data to analog data.

14. The method of claim 13, further comprising:
buffering the analog data; and
outputting the buffered analog data to a plurality of data lines of an LCD panel.
